(19) United States
(12) Patent Application Publication
(10) Pub. No.: US 2007/0060171 A1
(43) Pub. Date: Mar. 15, 2007

(54) Method and apparatus for developing location-based applications utilizing a location-based portal

(75) Inventors: Isaias Sudit, Delray Beach, FL (US); Jerome Longbottom, Coral Springs, FL (US); Naomi Morita, Mountain View, CA (US)

Correspondence Address: EDWARDS & ANGELL, LLP, P.O. BOX 55874, BOSTON, MA, 02205, US

(73) Assignee: LOC-AID Technologies, Inc., Boca Raton, FL (US)

(21) Appl. No.: 11/517,846

(22) Filed: Sep. 8, 2006

Related U.S. Application Data
(60) Provisional application No. 60/715,848, filed on Sep. 9, 2005.

(51) Int. Cl. H04Q 7/20

(52) U.S. Cl. 455/456.1

(57) ABSTRACT

A system for developing location-based applications comprising: a mobile device. A carrier-positioning infrastructure, communicating with the mobile device for enabling the use of location-based applications by the mobile device. A mobile location-based application provider providing location-based applications to the at least one mobile device. A mobile location-based application server. A location-based application residing at the server. The location-based application requiring location functionality for the location-based application to become functional with the mobile device. A portal, communicating with said location-based application. The portal storing location-based application functionality to be used by the location-based application stored at the location-based application server to enable the mobile device to operate the mobile location-based application.

### CROSS-REFERENCE TO RELATED APPLICATIONS

This Application claims priority to U.S. Provisional application 60/715,848 filed on Sep. 9, 2005 entitled METHOD AND APPARATUS FOR DEVELOPING LOCATION-BASED APPLICATIONS UTILIZING A STANDARDIZED LOCATION-BASED PLATFORM.

### BACKGROUND OF THE INVENTION

This invention is directed to a methodology and system for enablement of location-based applications for mobile devices such as cellular phones, and more particularly, to a method and apparatus which enables developers to develop applications without extensive knowledge regarding location-based services tools, standards and protocols.

With the advent of highly developed mobile devices such as cellular phones, and personal digital assistants, it has not only become possible to track the location of these devices, but it has become possible to enable these devices to perform applications, as known from applicant's U.S. patent application Ser. No. 11/067,790, entitled METHOD AND SYSTEM FOR MONITORING LOCATION OF A CELLULAR PHONE IN RELATION TO PREDEFINED GEOGRAPHIC AREA WITH AUTOMATIC NOTATION OF BOUNDARY VIOLATIONS to provide applications executable at the mobile device. This has resulted in a burgeoning industry for developers to develop location-based applications such as games, tracking, where is? applications and the like.

However, although developers are concerned with making use of the location-based services, they often are either not equipped, or do not wish to worry about how to build the required location-based tools, how to interface with a phone, how to write an application for multiple wireless carriers, how to obtain the mapping information required for location-based services or even to be responsible for determining which phones are enabled or authorized. Furthermore, working independently, the developer would be responsible for determining how the application interacts with the mobile wireless network and whether it meets certain carrier standards.

Another issue is that the individual carriers generally provide those available applications. They are provided by transmitting a menu to the mobile device in response to a request from the end user. The end user must first communicate to the carrier that it desires an application, which is then communicated from the carrier server to the mobile phone. The end user then scrolls through the application categories and selects a category communicating that selection to the carrier server. The carrier then transmits those applications or subcategories available under the selected category to the phone. The user then transmits a selection to the carrier server. This process and communication is repeated until a specific application is selected. The carrier server then transmits the parameters and executable code to the phone to be downloaded at the phone to enable that application. Although satisfactory, this reiterative communication suffers from the disadvantage that it is susceptible to the intermittent breakdowns in mobile communications. The process is time consuming as it requires cellular or radio transmission back and forth through several iterations of a menu, and in some instances, may add costly air time charges to the end user downloading the application for each desired application. As the use of location-based applications become more widely adopted, users will utilize several such applications on a single phone exacerbating the problems with the download and initialization issues, as well as taxing the “real estate” for downloaded code at the phone. Accordingly, a method and apparatus, which overcomes the shortcomings of the prior art, is desired.

### BRIEF SUMMARY OF THE INVENTION

A portal stores location-based application functions (application processes which operate at least in part on a target position determination), to be utilized by a location-based application. The location-based application server makes a call to the portal and operates on the result of the location-based application function. The portal also communicates with a carrier-positioning infrastructure to receive the position determination of a target portable device utilizing the carrier infrastructure. A portable device communicates with the portal in order to utilize the third party location-based application.

During use, the portal receives the determined position, such as the latitude, longitude or some other location identifier for the portable device. Utilizing the stored functions, the portal processes the position determination into a format capable of being used by the third party location-based application and cooperates with a third party application server to provide the necessary location-based functionality for utilization of the location-based application by the targeted mobile device.

In a preferred embodiment, the function may be as simple as building blocks for certain required location-based functionality, or may be as complex as an applet (substantially the entire location-based application). Furthermore, the portal may download the location-based functions to the target mobile device and control the enabling of the necessary building blocks for the desired application.

In a preferred embodiment, an entire suite of location-based application functions may be downloaded to the mobile device. As the functions are required to execute the third party location-based application, the portal enables the necessary functions at both the server and the mobile device. In this way, the executable code at the mobile device need only be downloaded once to support a number of location-based application products.

### BRIEF DESCRIPTION OF THE DRAWINGS

The foregoing and other objects, features and advantages of the present invention will be apparent from the following more particular description of preferred embodiments of the invention as illustrated in the accompanying drawings in which like reference characters refer to the same parts throughout the different views. The drawings are not necessarily to scale, emphasis instead being placed upon illustrating the principles of the invention.

FIG. 1 is a schematic diagram of a system for developing location-based applications in accordance with the invention;

FIG. 2 is an operational flow diagram for enabling location-based applications for a mobile device in accordance with the invention;

FIG. 3 is an operational flow diagram for enabling utilization of a location-based application on a mobile device in accordance with another aspect of the invention;

FIG. 4 is an operational flow diagram for the system for developing and enabling location-based applications for a portable device in accordance with a third embodiment of the invention;

FIG. 5 is a block schematic diagram of exemplary functionality of the portal server located within a system in accordance with the invention.

FIG. 6 is a block diagram representation of the functional components provided by the portal client in accordance with one embodiment of the invention; and

### DETAILED DESCRIPTION OF THE INVENTION

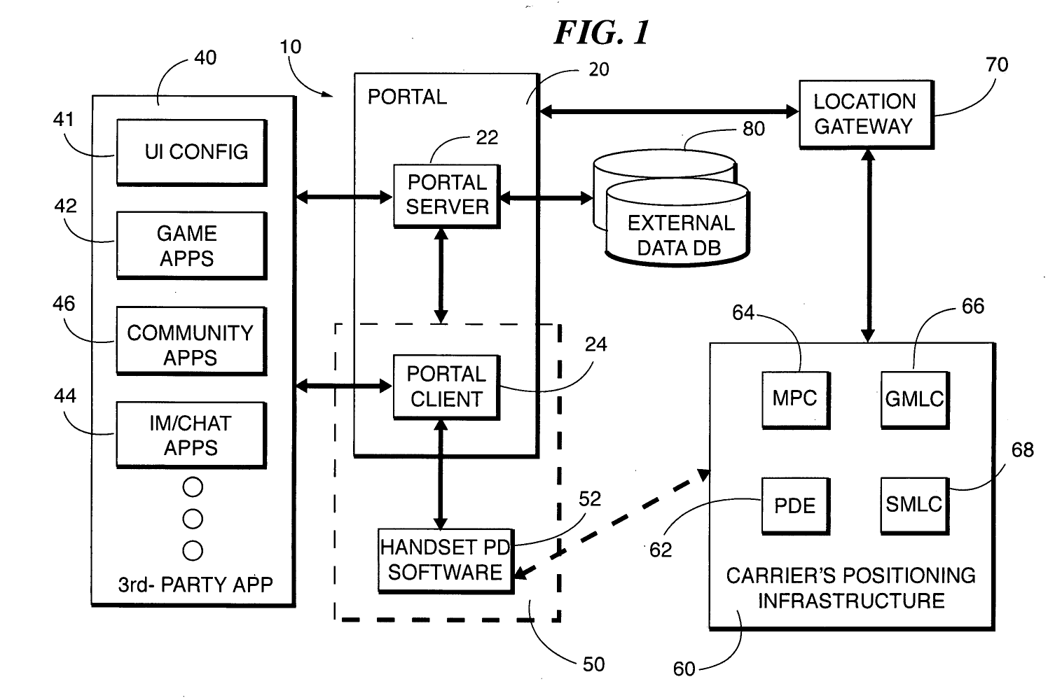

Reference is made to FIG. 1 in which a system, generally indicated as 10, includes a location-based application enabling portal 20, acting as a portal between location-based application providers, a targeted mobile device 50 and a carrier-positioning infrastructure 60 in which the targeted mobile device 50 operates.

An application source 40 is a collection of one or more third party servers 41-44 located at the application provider, i.e., the developer and source of location-based service applications. For ease of description, the application provider may be considered synonymous with the server for an application service provider. The application service provider may be any one of game applications server 42, by way of example a provider of FIND ME™, an instant message or chat-type of applications server 44 which provides location-based communication, a community application provider server 46 which provides either a communal game or a location-based e-commerce type of application in which target cellular phone users are driven to points of interest.

Mobile device 50, in the exemplary but non-limiting embodiment, a cellular phone, communicates with portal 20 and to location-based application servers 40 through portal 20. Mobile device 50 may include handset position determination hardware and software 52 to enable position determination requests to be made directly to carrier positioning infrastructure 60. In the alternative to software/hardware 52, phone 50 utilizes portal 20 to perform position determination.

An exemplary, but non-limiting example of such a carrier-positioning infrastructure 60 may include a position-determining entity (“PDE”) server 62 working in cooperation with a mobile-positioning center (“MPC”) 64 utilizing protocols to communicate between cellular phone 50 and portal 20 and/or mobile application provider servers 40. However, it should be noted that PDE 62 and MPC 64 may be any position-determining architecture such as a general mobile locating center (“GMLC”) 66 or a specific mobile locating center (“SMLC”) 68, the actual configuration being determined as a function of the communication technology or location technology utilized within carrier-positioning infrastructure 60.

Once an application has been developed, there are compatibility issues. Each country, even each service carrier, develops its own protocols for utilizing wireless services. Carriers may even use a plurality of location-based platforms or technologies within a network. Furthermore, as a result of the proprietary nature of carrier networks, one carrier may not allow another carrier to provide location-based service on its network, i.e., the protocols and technologies are designed to be cross-incompatible. To alleviate this issue, a gateway 70, as known from applicants' co-pending U.S. application Ser. No. 11/394,681 (referenced as if incorporated fully herein), is provided to allow communication and use of the location-based service application across a plurality of carrier-positioning infrastructures.

Portal 20 includes distinct functionality which for ease of description is considered a portal server 22 and a portal client 24. Portal server 22 receives the raw position information, such as latitude, longitude, or some other location identifier, from the carrier-positioning infrastructure 60 and converts it into a result which can be acted upon by the location-based applications provided by the application providers at third party application servers 40. By way of example, portal server 22 may produce an “in” or “out” signal for phone 50 relative to a predefined geographical boundary as required by the location-based application. Therefore, portal server 22 communicates with the various location-based application servers 40 in a manner which allows the location-based application servers 40 to call the required location function to make use of location information. In other words, portal 20 provides the building blocks of location functionality for the third party applications.

Portal server 22 acts as an exchange for position determination and dependent upon the sophistication of the third party application, serves as the host for the functionality required in response to third party application server calls from the third party application servers 40, or in the case of less sophisticated third party applications, portal server 22 may host an entire application server applet around which the application provider contributes only “look and feel” configurations such as those provided by a third party location-based application user interface server 41.

Portal server 22 may also interface with an external database 80. External database 80 includes information associated with applications such as configuration data such as logos or graphics, associated with a specific location-based applications, maps to be overlaid onto the raw location data, predetermined geographical points of interest or boundaries/areas of interest to a particular third party application or the like.

Portal server 22 further supports position determination by handling and processing the network-based and/or remote request for a target location.

Portal client 24 is the user facing portion of portal 20, and depending upon the bifurcation of responsibility, may be entirely dependent for functionality on portal server 22 or may perform some of the functionality discussed above with respect to portal server 22. In the preferred embodiment portal client 24 resides on phone 50. Portal 20 performs the entire functionality of providing the location based applets and building blocks, the “division of labor” of the location of these building blocks, applications and interfaces, as between portal server 22 and portal client 24 is a matter of design choice.

In the preferred embodiment, portal client 24 interfaces with a third party application either directly through its own application program interface, or through the portal server 22 acting as a virtual communication applet. As will be discussed below in some embodiments, the applets provided by portal client 24 are the defacto third party location based application.

In the preferred embodiment, portal client 24 is that portion of portal 20 which interacts with hardware and other software residing on cellular phone 50 and supports the phone position determination as well as the application subscriber, i.e., the user of cellular phone 50 user interface.

As discussed above, the requirements for portal server 22 and/or portal client 24 may be simplistic when the location-based aspects of a third party application are de minimus, such as providing a position determination for phone 50 or very sophisticated, such as when portal 20 is providing the applet for a multiparty game.

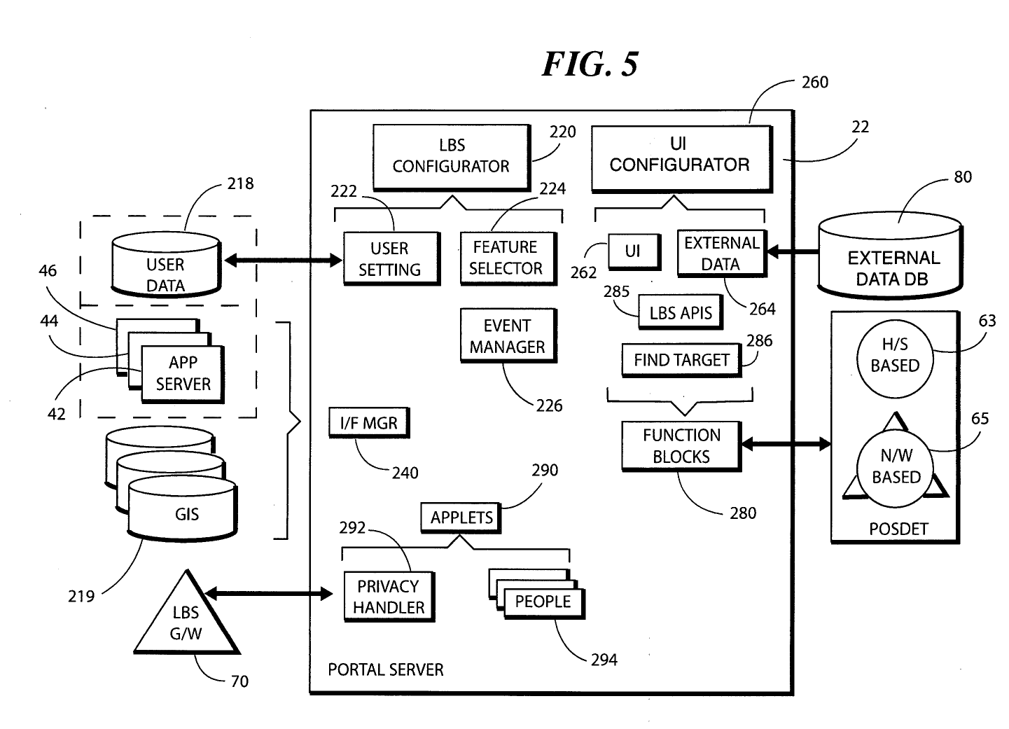

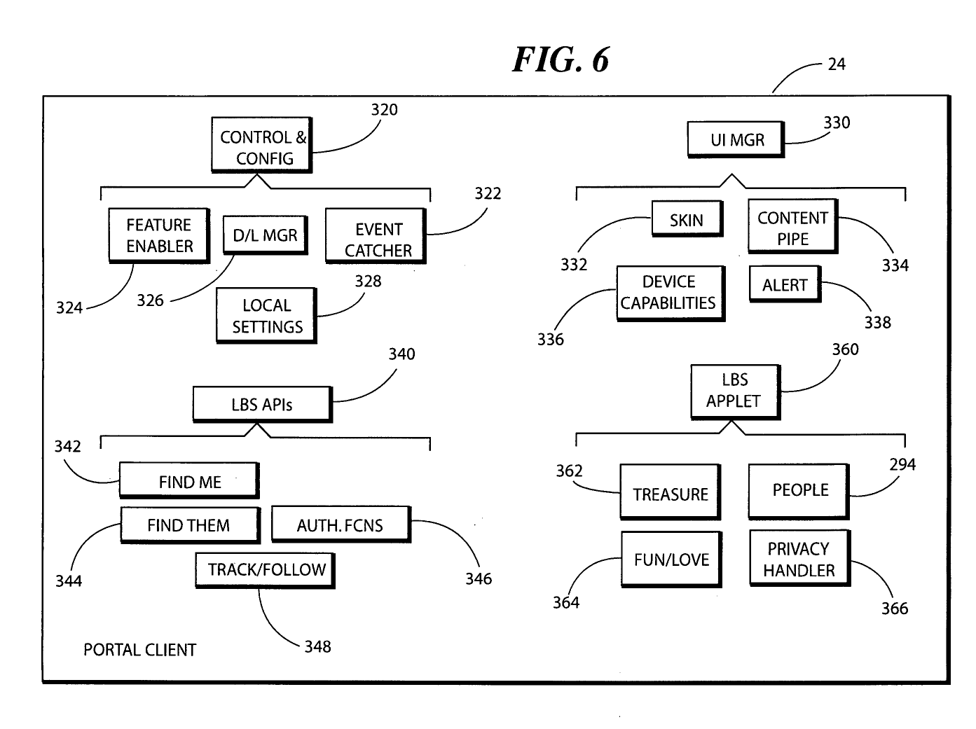

Reference is now made to FIGS. 5 and 6 in which a detailed description of portal 20 is provided.

Portal server 22 (FIG. 5) includes a location-based services (“LBS”) configurator 220. The location-based services application provider, at servers 40, utilizes LBS configurator 220 to instruct portal 20 with respect to which location functions are required to be enabled at phone 50 or the requestor drive in order for the location-based service application to operate at the cellular phone 50. As part of its functionality, location-based service configurator 220 includes a user settings file 222 for determining the application-specific settings, as a function of the LBS application needed to operate on function blocks and applets (as described below). A feature selector 224 selects which location-based functions are required to operate the application. Feature selector 224 monitors the location based application and determines which functions needs to be enabled. Exemplary functions are grant authorization to request, determination whether target phone is within applicable boundary, or determine which coffee shop is closest to location of phone. An event manager 226 determines an event occurrence such as a new end user phone must be authorized and sends instructions to portal client 24 to enable the necessary location-based function at cellular phone 50 corresponding to the new user.

Portal server 22 includes an interface manager 240 to allow communication between location-based application servers 40 and portal server 22. Portal server 22 also includes a user interface configurator 260. User interface configurator 260 operates on a user interface 262 and an external data processor 264 to determine how the application is to be presented on the target cellular phone 50 and/or end user cellular phone 50. External data database 80 provides the external data for the external data processor 264. By way of most simplistic example, external data database 80 may include the graphics to be associated with the location-based service application to be downloaded to, or streamed to, cellular phone 50 as part of the application. External database 80 may provide desired logos, graphics or formatting instructions that are utilized at phone 50 by the location-based applications, location boundaries for games, location of points of interest to cellular phone users (in conjunction with a nearest point of interest application). A user database 218 having similar data is associated with server 40 and may include other information.

As discussed above, functional code, in the form of function blocks and applets, is stored within portal 20. In this preferred, but not limiting, embodiment, function blocks 280 and applets 290 are stored in portal server 22 for operation thereon. Function block 280 includes location-based system application programming interface (“LBS/API”) 285 which by way of example may be a function as simple as a network call to the wireless carrier positioning infrastructure 60 as a find a target function 286. However, it may be any position determining function such as mapping a position determination to a map graphic (utilizing data stored in database 80 or called by portal 20 from an independent geographic information system (“GIS”) 219), determination of an “in/out” relative to a game triggering boundary, or any other functionality known in the art. It should be noted that in this embodiment, carrier infrastructure 60 is shown in functional terms as containing either a handset-based position-determining structure 63 or a network-based position-determining structure 65. This is merely the functional representation of the carrier-positioning infrastructure as embodied in FIG. 1.

Similarly, location-based functional code may be stored as more robust applets 290 which may include applications by way of non-limiting example such as privacy handler functionality 292 which would control access to target cellular phone 50 or a people find applet 294 which not only would find the location of a target cellular phone 50, but would also perform a function on the location such as determining distance from the requesting cellular phone to a target phone 50, or even provide a map and instructions for meeting the person associated with the targeted cellular phone 50.

Reference is now made to FIG. 6 in which the portal client functional components are shown. Function code in the form of function blocks and function applets may also be provided by portal client 24. Portal client 24, as known from the above, depending upon the features required for the application at issue, may communicate directly with application servers 40 or through portal server 22. Portal client 24, in the preferred embodiment, would not communicate with the carrier position identification structure, but would communicate directly through handset software 52 of cellular phone 50.

In the preferred embodiment portal client 24 is downloaded as an omnibus client to cellular phone 50. An omnibus client is the common location based functionality required by the majority of location based applications. It is a location-based function set. In accordance with the invention, the omnibus client is downloaded once, at the first request for a location based application.

Portal client 24 includes a control and configuration processor 320 for self configuring phone 50 as a function of requested location based application. Processor 220 includes an event catcher 322, which receives instruction from event manager 226 of portal server 22 to turn the desired functionality “on” or “off” at the user's cellular phone 50, as a function of the location based application requested for phone 50. Event catcher 322 communicates with a feature enabler 324 which disables or enables (turns function “on” or “off”) for the preloaded location-based application functions previously downloaded to cellular phone 50. Control and configuration processor 320 includes a download manager 326 for controlling the downloading of the location-based functionality to cellular phone 50. Control and configuration processor 320 also includes local settings controller for tracking 328 which functions have been enabled at cellular phone 50 or personal interface information such as selected user pseudonym for game play or graphical user interface selected by player at phone 50 such as wallpaper for phone, color schemes, ring tone alerts or the like.

As discussed above, portal client 24 is the cellular phone facing portion of portal 20. Accordingly, it includes a user interface manager 330 for configuring and controlling the interface of cellular phone 50. By way of example, user interface manager 330 includes a skin library 332 which stores data selected by the application creator for the look and feel of the application as it appears at cellular phone 50. This is a collection of graphics and graphic-enabling and/or animation-enabling instructions.

User interface manager 330 also includes a content pipe 334 which manages all data and executable code being downloaded to cellular phone 50 as a function of the enabled features at cellular phone 50. A device capability processor 336 stores the hardware capabilities of cellular phone 50 and manages the interface as a function of the hardware capabilities. By way of example, when downloading the location-based features to cellular phone 50, it will control the transfer rate, and even the size of the transferred file as a function of the cellular phone 50 capabilities. Lastly, an alert processor 338 creates messages in accordance with events monitored by the user interface manager 330 as a function of the enabled features.

In this embodiment, portal client 24 is sophisticated and therefore contains its own function blocks shown as LBS APIs 340 and its own LBS applets 360 which may be utilized by application servers 40 in executing the location-based service application. By way of example, LBS APIs 340 correspond to simple functional blocks such as FIND ME™ (what is my location?) 342, FIND THEM (what is a target cellular phone or point of interest location) 334, authorization of certain location-based functionality 346 or track and follow a target cellular phone 348.

Similarly, entire applets or portions of applets 360 which work either independently or in conjunction with applets 290 are stored within portal client 24 such as people 294, treasure 362 (an entire application for seeking an item in accordance with location-based clues or instructions sent to the cellular phone), fun/love 364 (a matching application, i.e., matching two enabled cellular phone users), or even a privacy handler application 366 (controls access to a target cellular phone which may be used in tandem), by way of example, within an applet such as fun/love 364 to prevent being targeted by an undesired participant.

The function blocks are the building blocks of code that could be incorporated into the code of the application provider's application and support the core location enabling functions of portal 20. These basic functions may be a map handler (displaying, updating, retrieval and reverse geocoding of a map for the cellular phone), it may include authorization and control (alerting and messaging in response to position determination relative to a geographic area), or find functionalities (finding a location of another user, or a point of interest lookup or location comparison). The basic building blocks may include a geographic tracking function or a boundary function to determine the relative position (in or out) or distance from a boundary.

The more sophisticated stored applets may be a conglomeration of building blocks, or an individual building block with more sophisticated processing code associated with the building block such as connecting two points or people to either locate a friend, arrange a date between two strangers based upon geographical location, identifying gathering places, monitoring content push. An applet may even provide entire games such as the previously mentioned treasure hunt.

Applets may also provide process management such as privacy and authorization management for certain third party developed applications. Applets may also provide back end control and management for the application such as provisioning a client configuration or controlling through feature enabler 324 the application codes which will be enabled for a specific end user.

To utilize portal 20, third party application provider at provider server 40 develops code for a basic application without writing code for the particular location-based functionality to be operated upon by the application. The application provider will make use of portal 20 and the stored location-based functions discussed above. By way of example, game application server 42 communicates with portal 20 either at the portal server level or the portal client level.

The developer will be assigned an identification ID, password and an application-specific access code. This information may be stored in external database 80. A menu will be provided for the available location-based functions to any one of application servers 40 to be utilized by the application developer. The developer will then build this LBS application utilizing the presented functions. Again, as discussed above, these functions may be as simple as building blocks 285, 340 such as location functions, messaging functions, sharing functions, boundary determination functions or the like, or entire game applets 290, 360 to which the application developer at game application server 42 may merely add as little as the graphics for look and feel, the “skin,” for the application. Once created, portal 20 maps the access code to the particular application to enable tracking of use and the control of necessary location-based functions and location-based application.

Once an application has been developed and the location-based functionality is determined, as in the normal course and in accordance with the prior art, the owner of cellular phone 50 makes a request for the third party application. Portal client 24 will download to cellular phone 50 an omnibus client as a function set, i.e., a plurality of location-based functions. This download will include more functionality than may be required by the requested location-based application. The omnibus function set will also be downloaded in a form consistent with the capabilities of the carrier network 60 and hardware constraints of the end user's cellular phone 50. In other words, portal 20 based upon communication with cellular phone 50 utilizing device capabilities processor 336 will determine the capabilities of cellular phone 50 before downloading the necessary code to make the location-based application executable at cellular phone 50.

The omnibus client may include location extraction for a phone-based position determination, code for authorization and privacy management, connectivity with the portal server 22. The portal client 24 maintains the primary phone 50 configuration while portal server 22 may maintain backup information. In certain “clientless” (those applications which do not require any type of building block or sophisticated applet), portal client 24 may be merely a conduit for instructions from portal server 22. These may be simple SMS or WAP applications in which the phone 50 is merely making a request for a self-position determination, a function conducted at portal server 22.

It should be noted that for ease of description, system 10 was described as including location based application servers 40 for hosting location based applications. However, as will be seen below, it is well within the contemplation and scope of the invention that location based applications may be hosted anywhere including but not limited to home computers, other mobile devices, the end user phone 50, even portal 20. All that is required is that the location based application wherever hosted make a function call to portal 20.

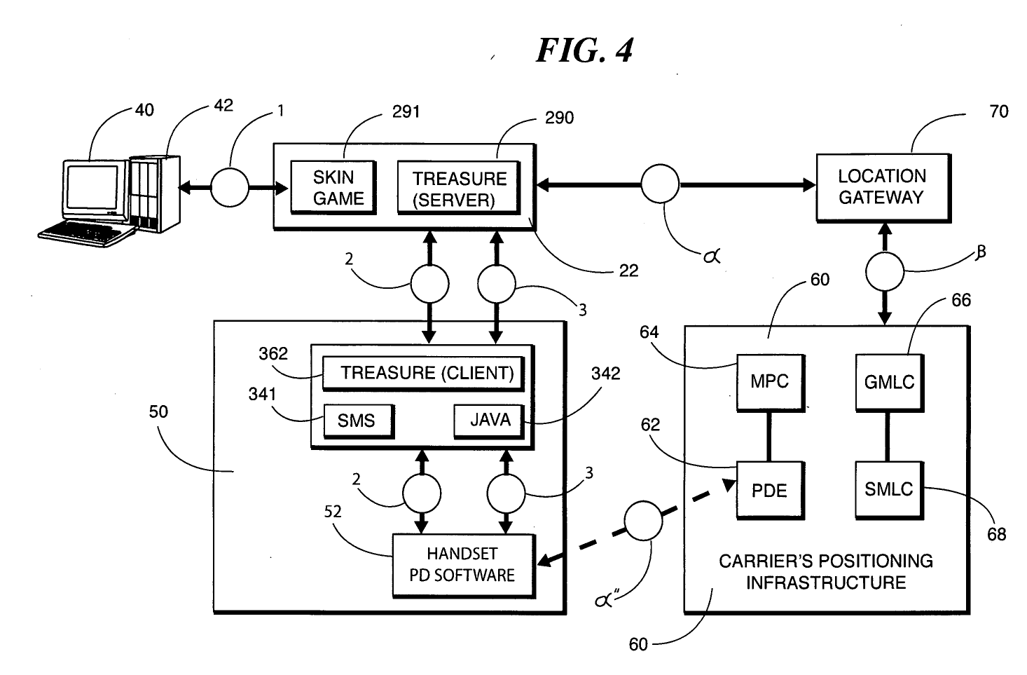

Reference is now made to FIG. 4 in which a call flow for a location-based application is provided. In this example, it is assumed that it is a third party application hosted at a third party location-based application server 42 (or home computer). In a first step, the application is developed as discussed above. Generally, user phone 50 will either request a download of the application or, once authorized to participate in the game and fully enabled, make a request to a third party provider to currently participate in the game for which they are authorized. The request passes through portal 20 to third party location-based application server 42. Application provider 40, utilizing a game application server 42, communicates in a step 1 with portal server 22 and makes an application programming interface (API) or call for the location-based functions necessary to execute the application with phone 50. If already a game participant, portal server 22 responds to the request by making a position determination of phone 50 and performing treasure applet 290, by way of example, while providing the look and feel of the game, i.e., the skin 291, as previously stored in database 80, to be utilized by portal server 22.

More specifically, in a step 2, the subscriber requests to opt in to the location-based application treasure applet 340 to participate. Phone 50 communicates through portal client 24. If cellular phone 50 has already participated in a location-based application with portal server 22, then location functions as discussed above are already stored on cellular phone 50 in portal client 24 and portal 20 merely leverages the existing function capability at phone 50 so that there is no download of code to phone 50, merely an instruction to enable the functionality necessary to participate in the treasure game.

In other words, treasure applet 241 is an enabled feature. Selector 224 of LBS configurator 220 instructs enabling of treasure applets 290 and 241 at portal server 22 and portal client 24 respectively. In this way the portal client 24 self-configures and turns on the treasure features within cellular phone 50.

Where this is a first time participation for cellular phone 50, then all of the functionalities for location-based applications capable of being downloaded by cellular phone 50 (an omnibus client, i.e. location function set) would be downloaded and only the functions necessary to participate in the treasure game would be enabled. Upon enablement, portal 20 notifies cellular phone 50 of the game's start.

Similarly, if this were a “clientless” configuration, in other words a position-determination only function (where is he?), then portal client 24 would merely be a conduit for SMS 41 messaging with location determined by portal server 22.

In steps 3, 3′, location compliance for operation of the location-based game is determined. Cellular phone 50 requests a position determination (where am I?), and makes the location-based function call (API) to portal 20. Portal client 24 passes the request to portal server 22. Portal server 22 interrogates the carrier-positioning infrastructure either directly or through location gateway 70 in steps α, β. Alternatively, the handset may directly interrogate the carrier position infrastructure 60 in a step α′ and forward the position determination through portal client 24 to portal server 22. Once position is determined by portal server 22 or handset 50, the rules of the game are applied by portal server 22 and portal client 24 utilizing applet functions 290, 340 respectively, and the next stage of the game is executed at cellular phone 50.

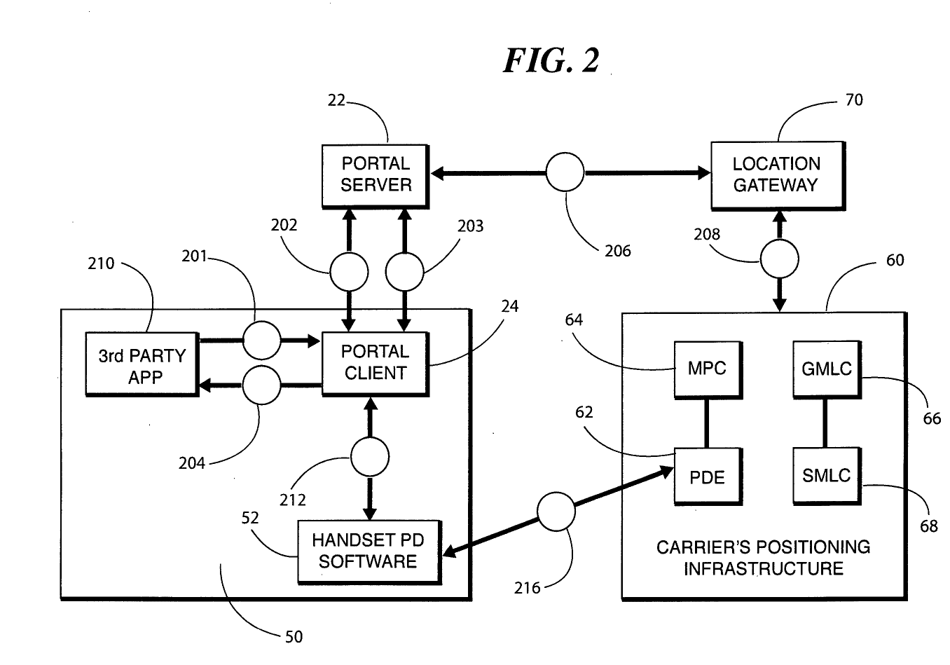

Reference is now made to FIG. 2 in which an operational flow diagram shows the steps in a call flow process utilizing a function block in accordance with the invention in which the location based application resides on cellular phone 50 and portal client 24 is robust. In this example, the third party application provides executable code residing on cellular phone 50. In short, portal server 22 determines whether cellular phone 50 is within a preset or specified boundary. If the conditions are met, the third party application is enabled and the location based function is provided by portal client 24.

In a step 201, handset 50, utilizing third party application 210 loaded thereon, makes an application program interface call utilizing portal client 24. In a step 202, position determination request/response is transferred from portal client 24 to portal server 22. Portal server 22 then makes a request in a step 206 requesting the location of the inquiring handset 50 through location gateway 70 to the network or carrier-positioning infrastructure 60 in a step 208. It should be noted, as discussed above, if there is no translation or platform configuration required, then handset 50 may utilize handset software 52 to perform the position determination directly to carrier positioning infrastructure 60 in a step 216. Such position determination information will then be transmitted to portal client 24 in a step 212 and in turn to portal server 22 in a step 203 as a location-based function call to provide the operations necessary to operate the application.

In another embodiment, in a step 203, portal server 22 performs a position determination and determines a position result, by way of example, whether cellular phone 50 is “in” or “out” of the determined area, and transmits such determination result to portal client 24 in a step 203. In turn, portal client 24 provides the result in a step 204 to allow, or not allow, participation in the application provided by third party application 210 as a function of the determination of portal server 22.

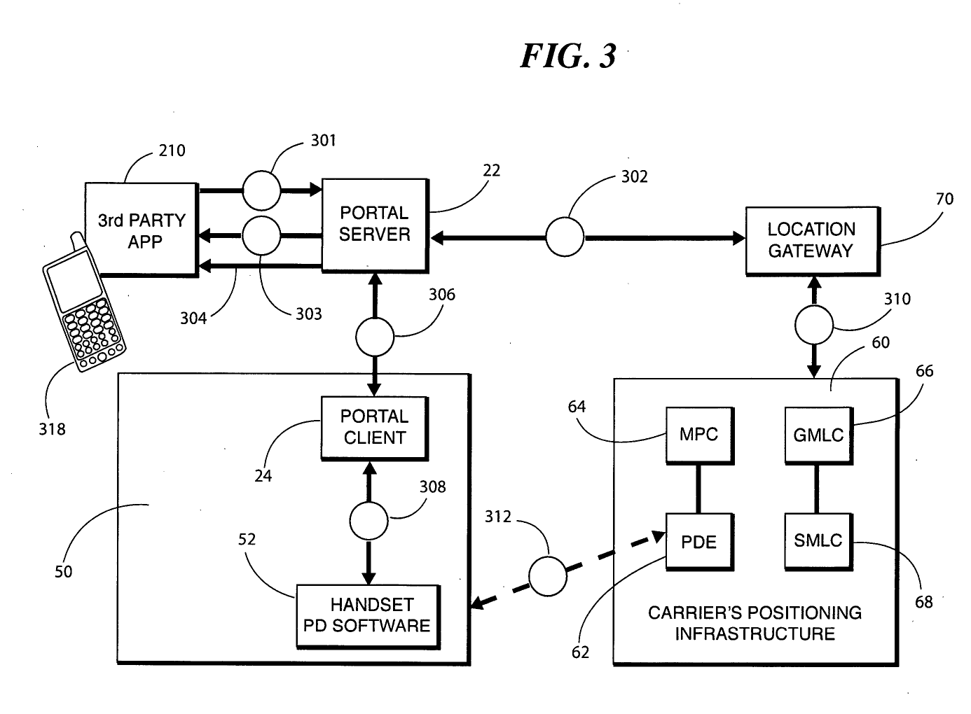

Reference is now made to FIG. 3 in which an operational flow diagram is provided for illustrating the process for operation of portal server 22 in which the third party application resides on a second mobile device such as a cellular phone or the like. Like numbers are utilized to illustrate like structure and processes for ease of discussion.

In this embodiment, the third party application 210 resides on a second mobile device 318 which may be a personal digital assistance (PDA), another cellular phone, a beeper, browser enabled device, or the like. In this scenario, mobile device 318 is a requesting device searching to be interactive with a target device such as cellular phone 50. In a step 301, requesting device 318 makes a request to portal server 22 by making an associated program interface call to portal server 22 to determine whether cellular phone 50 is in or out of the geographical area necessary to participate with third party application 210.

As discussed above, portal server 22 in one embodiment transmits the request in a step 302 to location gateway 70 which in turn transforms the request into a format appropriate to be operated upon by carrier positioning infrastructure 60. This is done in a step 310. Once determination is made by carrier positioning infrastructure 60, the raw location information is passed on to location gateway 70 as shown by arrow 310 and then back along pathway 302 to portal server 22. Portal server 22 location based then performs a function on the raw location information to produce a result as required to perform third party application 210.

Alternatively, where it is a handset based inquiry and there is no need for location gateway 70. Cellular phone 50 may make the position determination in a step 312 as discussed above. Portal server 22 communicates in step 306 with portal client 24 which passes the request along in step 308 to handset 50. Handset 50 directly communicates with carrier positioning infrastructure 60 in a step 312 to make a position determination inquiry. The position determination information is passed back to cellular phone 50 which may pass the raw data through portal client 24 in steps 306 to portal server 22. Portal server 22 then performs a location function and in a step 304 provides the processed position determination information to third party application 210 residing on requesting device 318 to enable third party application 210 to perform the third party application with cellular phone 50. In another embodiment portal client 24 may perform all or some of the functionality required by third party application 210 and pass the result to portal server 22 for transfer to third party application 210 or for further processing.

It should be noted that in each of the examples in FIGS. 2, 3, portal server 22 and portal client 24 may be operating to provide function blocks to third party application 210 or entire applets as discussed above.

By providing a portal which stores location-based application functionality to be utilized by a location-based application service provider at its own server, a broad range of location-based services functionality may be provided through a single portal. This allows downloading of entire location-based functionality to the cellular phone with the corresponding control of that functionality. Therefore, additional functions are auto-enabled, i.e., without the need to download an entire application with all its functionality. It also allows third party application providers to create applications without the necessity to write code for the pure location based functionality. By storing entire location-based applets, third party application creation is facilitated because the third party need only provide the graphics corresponding to the application to provide the branded or source based look and feel without the requirement for additional download after the initial download.

Thus, while there have been shown, described and pointed out novel features of the present invention as applied to preferred embodiments thereof, it will be understood that various omissions and substitutions and change in the form and detail are contemplated so that the disclosed invention may be made by those skilled in the art without departing from the spirit and scope of the invention. It is the intention therefore to be limited only as indicated by the scope of the claims appended hereto. It is also to be understood that the following claims are intended to cover all of the generic and specific features of the invention herein described and all statements of the scope of the invention, which as a matter of language, might be said to fall there between.

What is claimed as new and desired to be protected by Letters Patent of the United States is:

1. A system for developing location-based applications comprising:
a mobile device;
a carrier-positioning infrastructure, communicating with the mobile device for determining the position of the mobile device;
a location-based application hosted within the system, said location-based application requiring a location function to enable said mobile device to operate said location-based application; and
a portal, communicating with said location-based application and said mobile device, said portal storing the location-based application function to be used by said location-based application to enable said mobile device to operate said mobile location-based application.

2. The system of claim 1, wherein said portal causes a plurality of location-based application functions to be downloaded to said mobile device and enabling only said location-based functions required for operation of said location-based application.

3. The system of claim 1, wherein said location-based functions are one of building blocks and applets.

4. The system of claim 1, wherein said portal retrieves raw data representing the location of said mobile device and performs a location-based function on said raw data to produce a location-based result, said location-based application operating on said result.

5. The system of claim 4, wherein said portal includes a portal server and a portal client, said portal client being downloaded to said mobile device as an omnibus client and at least one of said portal client and said mobile device performing a position determination, and at least one of said portal server and said portal client producing the location-based result as a function of said position determination.

6. The system of claim 1, further comprising a database associated with said portal, said database storing a location-based application identifier, a location-based application provider identifier, and an end user identifier, said portal communicating with said database to apply the appropriate function to the appropriate application.

7. The system of claim 1, wherein said building blocks are one of locate the mobile device, find a second mobile device, determine whether the mobile device is “in” or “out” of a boundary, privacy management, and authorization.

8. The system of claim 1, wherein said applets are one of treasure hunt, privacy handler and people finder.

9. The system of claim 1 further comprising a location based application server, the location based application being hosted by the location based application server.

10. The system of claim 1, further comprising a second mobile device, the location based application being hosted on the second mobile device.

11. The system of claim 1, wherein said location based application is hosted on said mobile device.

12. A portal for enabling third party location-based applications, the portal communicating with a mobile device and a location-based application, the portal storing a location-based function, said location-based function being provided by said portal to the location-based application in response to an application processing interface from said location-based application to enable said mobile device to execute a location-based application.

13. The portal of claim 11, wherein said portal includes an omnibus client, said omnibus client being downloaded to said mobile device and enables, at the mobile device, the specific location-based function necessary to execute said location-based application.

14. The portal of claim 11, wherein said location-based function is one of building blocks and applets.

15. The portal of claim 11, wherein said portal makes a mobile device position determination by retrieving raw location data representing the location of said mobile device and performs a location function on said raw data to produce a location-based result operated upon by said location-based application.

16. The portal of claim 14, wherein said portal includes a portal server and a portal client, said portal server performing a position determination of said mobile device, said portal client server communicating with said mobile device and one of said portal server and said portal client producing the location-based result as a function of said position determination.

17. A method for developing a location-based application for use by a mobile device comprising:
storing a location-based function set at a portal;
providing a location-based application in communication with said portal;
downloading an omnibus client to a mobile device; and
enabling at the mobile device only that location-based function necessary to perform the location-based application.

18. The method of claim 17, further comprising the steps of:
the mobile device making a request to the portal to utilize the location-based application, at the mobile device, the portal enabling the location based function at the mobile device as a function of the location based application request.

19. The method of claim 17, further comprising the steps of:
the portal making a position determination in response to the request;
the portal producing a location result as a function of the position determination; and
the location-based application utilizing the location result in executing the location-based application for use by the mobile device.

20. The method of claim 17, wherein said portal utilizes said omnibus client to produce the location result.

21. The method of claim 17, wherein said location-based function is one of a location block and applet.

22. The method of claim 17, wherein said portal makes a position determination by interrogating a carrier positioning infrastructure.

23. The method of claim 17, wherein the mobile device interrogates a carrier positioning infrastructure to obtain raw location data with respect to the mobile device, and transmits said raw location data to said portal, the portal making a position determination as a function of the raw location data.

24. The method of claim 17, further comprising the steps of storing skins associated with the location-based application, said portal applying the skins at the mobile device when the mobile device executes the location-based application.

25. The method of claim 17, further comprising the steps of assigning an identification ID to said location based application and storing the identification ID at the portal, the portal mapping access to the location-based application as a function of the identification ID for tracking use and control of the location-based application.
